(19) United States
(12) Patent Application Publication
(10) Pub. No.: US 2019/0258097 A1
(43) Pub. Date: Aug. 22, 2019

(54) METHOD FOR PREPARING INTELLIGENT DISPLAY FILM HAVING SWITCHABLE VIEWING ANGLE AND COMPOSITE FILM CONTAINING DISPLAY FILM

(71) Applicants: TIANJIN CAVISION PHOTOELECTRIC TECHNOLOGY CO., LTD., Tianjin (CN); BEIJING CAVISION PHOTOELECTRIC TECHNOLOGY CO., LTD., Beijing (CN)

(72) Inventors: Zemin HE, Tianjin (CN); Wenjiang TANG, Tianjin (CN); Rihua YU, Beijing (CN); Shaoqi YANG, Tianjin (CN); Chaofeng SHANG, Tianjin (CN); Panpan PAN, Tianjin (CN); Yongxing YU, Tianjin (CN); Suyan DING, Tianjin (CN)

(73) Assignees: TIANJIN CAVISION PHOTOELECTRIC TECHNOLOGY CO., LTD., Tianjin (CN); BEIJING CAVISION PHOTOELECTRIC TECHNOLOGY CO., LTD., Beijing (CN)

(21) Appl. No.: 16/342,098

(22) PCT Filed: Mar. 31, 2017
(86) PCT No.: PCT/CN2017/078916

§ 371 Date: Apr. 15, 2019

(30) Foreign Application Priority Data
Oct. 19, 2016 (CN) 201610912621.6
Oct. 19, 2016 (CN) 201621138713.5

(51) Int. Cl. G02F 1/1334; G02F 1/1335; G02F 1/1343; G02F 1/1337; C09K 19/54; C08F 222/10; C08F 220/18

(52) U.S. Cl. CPC G02F 1/1334; G02F 1/133502; G02F 1/13439; G02F 1/133788; C09K 19/544; C08F 222/1006; C08F 2800/20; G02F 2201/50; G02F 2202/28; G02F 2202/022; C08F 2222/1013; C08F 2222/108; C08F 220/18

(57) ABSTRACT

A method for preparing an intelligent display film having a switchable viewing angle and a composite film containing the display film includes: mixing liquid crystal and a photopolymerizable monomer according to certain percentage content, wherein the ratio of raw materials is selected according to the refractive index matching ability between a conductive film and a polymer-dispersed liquid crystal layer as well as the characteristics of material components, and wherein the percentage content of the liquid crystal is 30-60%, the percentage content of the photopolymerizable monomer is 38-70%, the percentage content of a photoinitiator is 0.1-3.5%, the percentage content of a spacer is 0.1-5%; stirring the liquid crystal, the photopolymerizable monomer, the photoinitiator and the spacer evenly at room temperature, pressing the mixed material between two indium tin oxide-coated conductive films by using a rolling process to form a thin layer, and irradiating the thin layer for 5-10 minutes by using ultraviolet light.

### TECHNICAL FIELD

The present invention relates to a method for preparing an intelligent display film having a switchable viewing angle and a composite film containing the display film, which is applied to the fields of optical displays such as smart phones and flat panel displays.

### BACKGROUND

Currently, the liquid crystal display technology is a dominant flat panel display technology. After years of development, there have been continuous advances in the liquid crystal display technology, and the key indicators of liquid crystal display such as resolution, brightness and viewing angle have been greatly improved. In particular, the wide viewing angle technology has been widely applied in liquid crystal display. In the fields of display technologies, when people have different requirements on the viewing angle width during displaying of information on a liquid crystal display device in different situations, one can use a liquid crystal display device having a narrow viewing angle to achieve confidentiality in liquid crystal display, and use a liquid crystal display device having a wide viewing angle to meet the requirement of viewing the display information of the liquid crystal display device from multiple angles by multiple people simultaneously. Although the wide viewing angle is very important for liquid crystal display, the privacy cannot be achieved in the case of wide viewing angle in certain applications, such as withdrawal, password input and viewing private information. Therefore, there is an urgent need for a product having a switchable viewing angle in which the viewing angle can be adjusted according to the usage occasions and user requirements so as to achieve peep-proof function.

At present, in the liquid crystal display technology, the director backlight technology can realize switching between a wide viewing angle and a narrow viewing angle, but the technology has extremely high requirements on the manufacture of the light guide plate and the LED lighting bar, and it is difficult for the general backlight manufacturer to meet the design requirements.

The existing technologies as mentioned in patents such as CN 205405002 U, CN 103605237 B and CN 204790254 U all disclose the application of a diffuser having a switchable view angle in liquid crystal display, but the method for preparing a diffuser having a switchable liquid crystal display viewing angle has not yet been disclosed in the existing technologies. In the prior art, switching between a wide viewing angle and a narrow viewing angle cannot be realized in the same liquid crystal display device, and the user's demand for diverse display of the liquid crystal display device cannot be satisfied.

### SUMMARY

One object of the present invention is to provide a method for preparing an intelligent display film having a switchable viewing angle, which can realize high transmittance in the wide viewing angle state, low voltage driving and display film application characteristics under the premise of ensuring the electro-optic property of the film material, and can achieve the switching of the display state between a wide viewing angle and a narrow viewing angle.

In order to achieve the above object, the present invention adopts the following technical solutions.

The present invention provides a method for preparing an intelligent display film having a switchable viewing angle, comprising the following steps:

mixing liquid crystal and a photopolymerizable monomer according to certain percentage content, wherein the ratio of raw materials is selected according to the refractive index matching ability between a conductive film and a polymer-dispersed liquid crystal layer as well as the characteristics of material components, and wherein the percentage content of the liquid crystal is 30-60%, the percentage content of the photopolymerizable monomer is 38-70%, the percentage content of a photoinitiator is 0.1-3.5%, the percentage content of a spacer is 0.1-5%; stirring the liquid crystal, the photopolymerizable monomer, the photoinitiator and the spacer evenly at room temperature, pressing the mixed material between two indium tin oxide-coated conductive films by using a rolling process to form a thin layer with a thickness of 100 μm, and irradiating the thin layer at 25° C. for 5-10 minutes by using ultraviolet light with a light intensity of 10 mw/cm², so as to prepare the intelligent display film having a switchable viewing angle.

The intelligent display film having a switchable viewing angle described in the present invention has a wide viewing angle in the non-powered state and a narrow viewing angle in the powered state, and the adjustment between a wide viewing angle and a narrow viewing angle can be achieved by adjusting the magnitude of the externally-applied voltage.

Preferably, the liquid crystal is a nematic liquid crystal having a refractive index of 1.4-1.52.

Preferably, the photopolymerizable monomer is a photopolymerizable monomer having a refractive index of 1.4-1.52.

Preferably, the photopolymerizable monomer comprises one or more components of hydroxypropyl acrylate, hydroxypropyl methacrylate, lauryl acrylate, lauryl methacrylate, isobornyl acrylate, isobornyl methacrylate, 1,6-hexanediol diacrylate, ethylphenoxy acrylate, ethylphenoxy methacrylate, 3,3,5-trimethylcyclohexyl acrylate, benzyl methacrylate, hexyl acrylate, hexyl methacrylate, polyethylene glycol diacrylate, ethoxylated bisphenol A dimethacrylate.

Preferably, the refractive index of the indium tin oxide-coated conductive film is between 1.46 and 1.52, and the refractive index of the polymer-dispersed liquid crystal layer is close to that of the conductive film.

Preferably, the spacer has a particle size of 2-10 μm.

Preferably, the intelligent display film having a switchable viewing angle has a driving voltage AC of 0-10V, a film thickness of 100 μm, and a transmittance of ≥76% in the wide viewing angle state, and a transmittance of ≥88% in the narrow viewing angle state.

Preferably, the intelligent display film having a switchable viewing angle can switch between a wide viewing angle state and a narrow viewing angle state during the changing of the externally-applied electric field, and the switching of the display state between a wide viewing angle and a narrow viewing angle can be realized between a backlight module and a display module.

Preferably, the intelligent display film having a switchable viewing angle has an adjustable refractive index, and has compatibility with other optical display films in a display backlight module.

The polymer-dispersed liquid crystal in the intelligent display film having a switchable viewing angle of the present invention is a photoelectric response material, and in the film having a switchable viewing angle, the liquid crystal droplets are uniformly dispersed in the polymer matrix. Under the action of the externally-applied electric field, the film having a switchable viewing angle completes the switching between a wide viewing angle in the non-powered state and a narrow viewing angle in the powered state. Moreover, the main characteristic of the film having a switchable viewing angle lies in that the transmittance of the film can reach above 76% in the wide viewing angle state, without affecting the overall energy consumption of the backlight module of the display, and the transmittance is up to 88% or more in the narrow viewing angle state. The angle of the viewing angle switching between a wide viewing angle and a narrow viewing angle can reach ±15°, and the film having a switchable viewing angle is an ultrathin film having a high transmittance in the wide viewing angle state.

Another object of the present invention is to provide a composite film comprising an intelligent display film having a switchable viewing angle, which can realize high transmittance in the wide viewing angle state, low voltage driving and display film application characteristics under the premise of ensuring the electro-optic property of the film material, and can achieve the switching of the display state between a wide viewing angle and a narrow viewing angle.

In order to achieve the above object, the present invention adopts the following technical solutions.

The present invention provides a composite film comprising an intelligent display film having a switchable viewing angle, comprising the structure of: a first release protective film layer 100, an anti-glare coating layer 101, a first PET layer 102, a first indium tin oxide conductive layer 103, a polymer-dispersed liquid crystal layer 104, a second indium tin oxide conductive layer 105, a second PET layer 106, an optical grade glue layer 107, an ultrafine louver layer 108, a third PET layer 109, and a second release protective film layer 110 which are arranged in order from top to bottom.

Further, a self-adhesive layer 111 is disposed between the third PET layer 109 and the second release protective film layer 110.

Preferably, the anti-glare coating layer can reduce specular reflection to achieve an anti-glare effect.

Preferably, the liquid crystal in the polymer-dispersed liquid crystal layer is a nematic liquid crystal, and the polymer is an acrylate monomer. The polymer-dispersed liquid crystal layer is formed by polymerizing a nematic liquid crystal and an acrylate monomer through 365 nm UV light. Under the externally-applied electric field, the transmittance and the viewing angle range of the intelligent display composite film having a switchable viewing angle can be adjusted.

Preferably, upon the light passes through the ultrafine louver layer, the display effect with a narrow viewing angle of ±30 degrees is formed.

Preferably, the intelligent display composite film having a switchable viewing angle can switch between a wide viewing angle and a narrow viewing angle, and has a wide viewing angle of ±60 degrees in the non-powered state and a narrow viewing angle of ±30 degrees in the powered state. By adjusting the magnitude of the externally-applied voltage, the film can be adjusted between a wide viewing angle and a narrow viewing angle.

Preferably, the first PET layer, the second PET layer, the first indium tin oxide layer and the second indium tin oxide layer, and the polymer-dispersed liquid crystal layer have similar refractive indices, which are all between 1.45 and 1.5.

In the present invention, the first PET layer, the second PET layer, the first indium tin oxide layer and the second indium tin oxide layer correspond to the intelligent display film having a switchable viewing angle prepared in the present invention.

Preferably, the intelligent display composite film having a switchable viewing angle as a whole has an adjustable refractive index, and has compatibility with other optical display films in a display backlight module.

Preferably, the intelligent display composite film having a switchable viewing angle has a driving voltage AC of 0-10V, a film thickness of 500-600 μm, a transmittance up to above 75% in the wide viewing angle state, and a transmittance up to above 90% in the narrow viewing angle state. It has good display characteristics and thus can be applied to the fields of optical displays such as computers, smart phones and ATM displays.

The polymer-dispersed liquid crystal in the intelligent display composite film having a switchable viewing angle of the present invention is a photoelectric response material, and in the film having a switchable viewing angle, the liquid crystal droplets are uniformly dispersed in the polymer matrix. Under the action of the externally-applied electric field, the film having a switchable viewing angle completes the switching between a wide viewing angle in the non-powered state and a narrow viewing angle in the powered state, and therefore can meet the requirement of an ultrathin film having a switchable viewing angle and a high transmittance in the wide viewing angle state.

### BRIEF DESCRIPTION OF THE DRAWINGS

FIG. 1 shows a voltage-transmittance electro-optic characteristic curve of an intelligent display film having a switchable viewing angle prepared in Example 1.

FIG. 2 shows a viewing angle-brightness curve of an intelligent display film having a switchable viewing angle prepared in Example 1 in a display backlight module.

FIG. 3 shows a viewing angle-brightness curve of an intelligent display film having a switchable viewing angle prepared in Example 1 composited with a peep-proof film in a display backlight module.

FIG. 4 shows a viewing angle-brightness curve of an intelligent display film having a switchable viewing angle prepared in Example 2 in a display backlight module.

FIG. 5 shows a viewing angle-brightness curve of an intelligent display film having a switchable viewing angle prepared in Example 2 composited with a peep-proof film in a display backlight module.

FIG. 6 shows a viewing angle-brightness curve of an intelligent display film having a switchable viewing angle prepared in Example 3 in a display backlight module.

FIG. 7 shows a diagram illustrating the principle of the wide viewing angle mode and the narrow viewing angle mode of an intelligent display film having a switchable viewing angle.

FIG. 8 shows a cross-sectional structural view of an intelligent display composite film having a switchable viewing angle in Example 4.

FIG. 9 shows a diagram illustrating the structural principle of the wide and narrow viewing angle modes of an intelligent display composite film having a switchable viewing angle in Example 4.

FIG. 10 shows a viewing angle-brightness curve of an intelligent display composite film having a switchable viewing angle of Example 4 in a display backlight module.

FIG. 11 shows a cross-sectional structural view of an intelligent display composite film having a switchable viewing angle in Example 5.

FIG. 12 shows a viewing angle-brightness curve of an intelligent display composite film having a switchable viewing angle of Example 5 in a display backlight module.

### REFERENCE SIGNS

100. first release protective film layer; 101. anti-glare coating layer; 102. first PET layer; 103. first indium tin oxide conductive layer; 104. polymer-dispersed liquid crystal layer; 105. second indium tin oxide conductive layer; 106. second PET layer; 107. optical grade glue layer; 108. ultrafine louver layer; 109. third PET layer; 110. second release protective film layer; 111. self-adhesive layer.

### DETAILED DESCRIPTION OF THE PRESENT INVENTION

The following examples will provide further understanding of the present invention for those skilled in the art, but are not intended to limit the present invention in any way. It should be noted that a number of variations and modifications may be made by those of ordinary skill in the art without departing from the concept of the present invention, and these variations and modifications are all belong to the scope of protection of the present invention. The present invention will be described in detail below with reference to the accompanying drawings and specific examples.

### Example 1

Liquid crystal and a photopolymerizable monomer were mixed according to certain percentage content, wherein the refractive index of the transparent ITO conductive film was 1.47, and the refractive index of the nematic liquid crystal SLC1717 (Shijiazhuang Yongshenghuaqing Liquid Crystal Co., Ltd.) was 1.512; and wherein the content of the liquid crystal was 30% of the total mass, the photopolymerizable monomer was a mixture of polyethylene glycol diacrylate having a refractive index of 1.47, 1,6-hexanediol diacrylate having a refractive index of 1.456,and hydroxypropyl methacrylate having a refractive index of 1.447 in a mass ratio of 3:4:3; the content of the photopolymerizable monomer was 69.5%, and the content of a photoinitiator was 0.4%, and the glass microbead having a particle size of 10 μm was selected as a spacer, with a content of 0.1%. The liquid crystal, the photopolymerizable monomer, the photoinitiator and the glass microbeads were stirred uniformly at room temperature, then the mixture was pressed between two indium tin oxide-coated conductive films by using a rolling process to form a thin layer with a thickness of 100 μm, and the thin layer was irradiated at 25° C. for 5 minutes by using ultraviolet light with a light intensity of 10 mw/cm² and a wavelength of 365 nm, so as to prepare an intelligent display film having a switchable viewing angle.

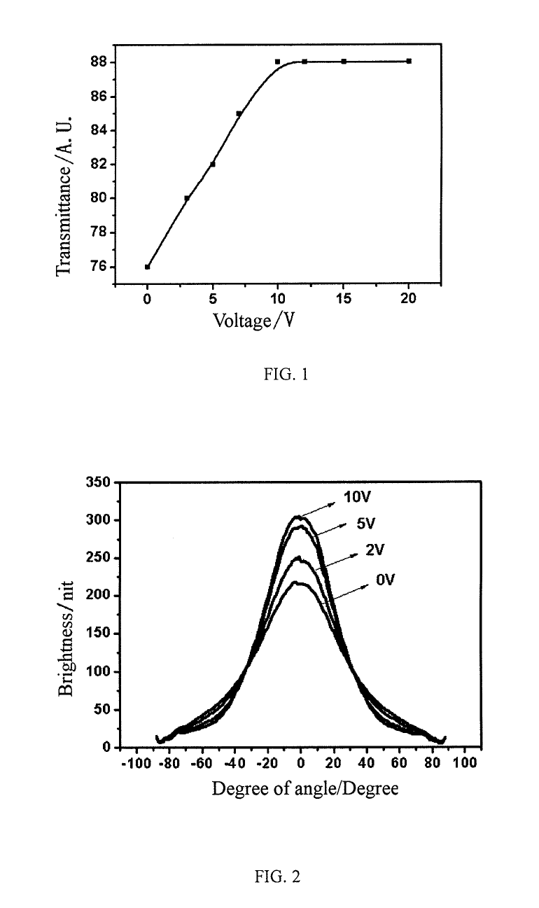

The intelligent display film having a switchable viewing angle obtained by the above preparation method was measured by a micrometer in terms of thickness, and its thickness was 100 μm. The voltage-transmittance electro-optic characteristic curve is as shown in FIG. 1. As the voltage increases, the transmittance increases. The transmittance in the wide viewing angle state is 76%, the transmittance in the narrow viewing angle state is 88%, and the driving voltage can be as low as 10V.

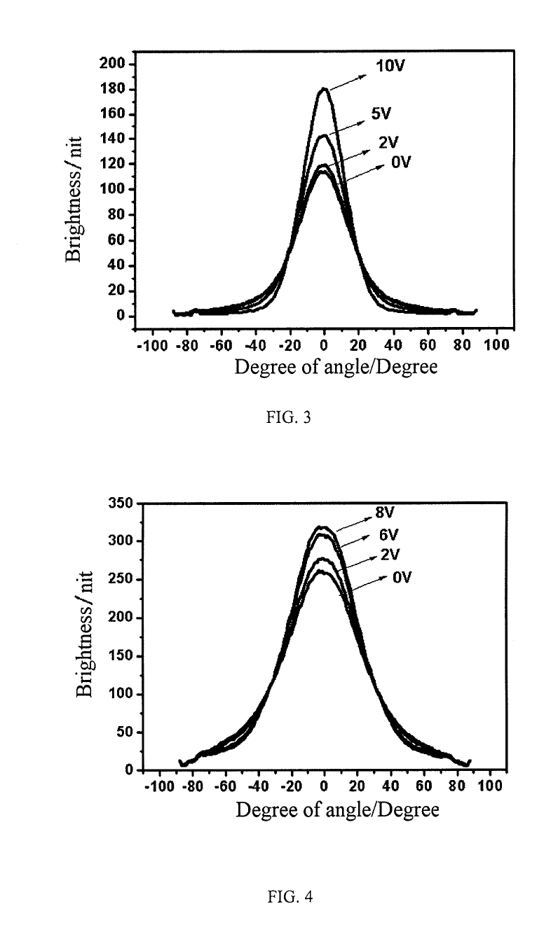

The intelligent display film having a switchable viewing angle was added to a liquid crystal display backlight module, and its viewing angle-brightness curve is as shown in FIG. 2. With the change of the driving voltage, there is a certain change in the viewing angle, and thus the effect of adjusting the viewing angle is achieved. After the intelligent display film having a switchable viewing angle was composited with a peep-proof film having a refractive index of 1.5, the viewing angle-brightness curve was measured in the liquid crystal display backlight module, as shown in FIG. 3. With the change of the driving voltage, the intelligent display film having a switchable viewing angle realizes the effect of switching between a wide viewing angle and a narrow viewing angle.

### Example 2

Liquid crystal and a photopolymerizable monomer were mixed according to certain percentage content, wherein the refractive index of the transparent ITO conductive film was 1.47, and its thickness was 50 μm, and the refractive index of the nematic liquid crystal SLC1717 (Shijiazhuang Yongshenghuaqing Liquid Crystal Co., Ltd.) was 1.512; and wherein the content of the liquid crystal was 45% of the total mass, the photopolymerizable monomer was a mixture of polyethylene glycol diacrylate having a refractive index of 1.47, isobornyl methacrylate having a refractive index of 1.477, and hydroxypropyl methacrylate having a refractive index of 1.447 in a mass ratio of 3:6:1; the content of the photopolymerizable monomer was 46.5%, and the content of a photoinitiator was 3.5%, and the spacer having a particle size of 5 μm was selected, with a content of 5%. The liquid crystal, the photopolymerizable monomer, the photoinitiator and the glass microbeads were stirred uniformly at room temperature, then the mixture was pressed between two indium tin oxide-coated conductive films by using a rolling process to form a thin layer with a thickness of 100 μm, and the thin layer was irradiated at 25° C. for 5 minutes by using ultraviolet light with a light intensity of 10 mw/cm² and a wavelength of 365 nm, so as to prepare an intelligent display film having a switchable viewing angle.

The intelligent display film having a switchable viewing angle obtained by the above preparation method was measured by a micrometer in terms of thickness, and its thickness was 100 μm. As the voltage increases, the transmittance increases. The transmittance in the wide viewing angle state is 78%, the transmittance in the narrow viewing angle state is 88%, and the driving voltage can be as low as 8V.

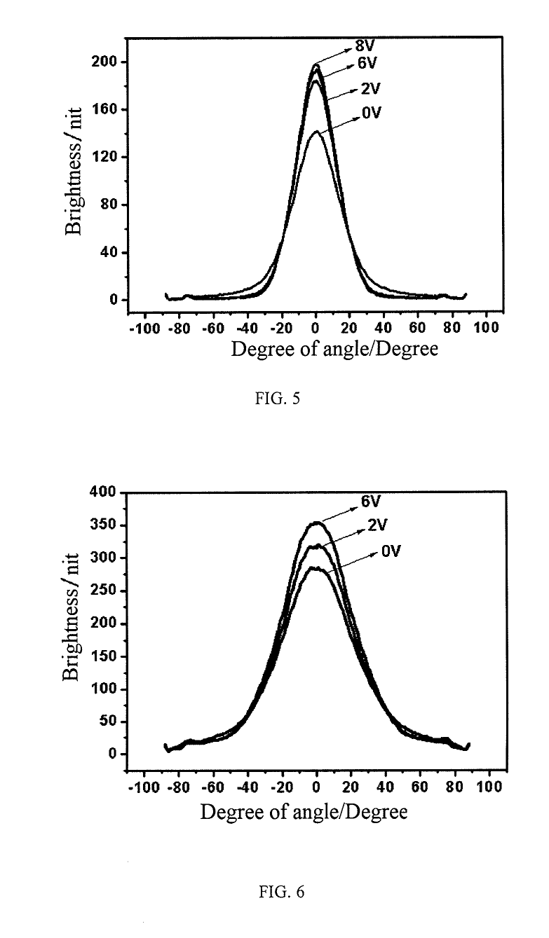

The intelligent display film having a switchable viewing angle was added to a liquid crystal display backlight module, and its viewing angle-brightness curve is as shown in FIG. 4. With the change of the driving voltage, there is a certain change in the viewing angle, and thus the effect of adjusting the viewing angle is achieved. After the intelligent display film having a switchable viewing angle was composited with a peep-proof film having a refractive index of 1.5, the viewing angle-brightness curve was measured in the liquid crystal display backlight module, as shown in FIG. 5. With the change of the driving voltage, the intelligent display film having a switchable viewing angle realizes the effect of switching between a wide viewing angle and a narrow viewing angle.

### Example 3

Liquid crystal and a photopolymerizable monomer were mixed according to certain percentage content, wherein the refractive index of the transparent ITO conductive film was 1.47, and its thickness was 50 μm, and the refractive index of the nematic liquid crystal SLC1717 (Shijiazhuang Yongshenghuaqing Liquid Crystal Co., Ltd.) was 1.512; and wherein the content of the liquid crystal was 60% of the total mass, the photopolymerizable monomer was a mixture of polyethylene glycol diacrylate having a refractive index of 1.47, 1,6-hexanediol diacrylate having a refractive index of 1.456, and hexyl methacrylate having a refractive index of 1.458 in a mass ratio of 3:1:1; the content of the photopolymerizable monomer was 38.5%, and the content of a photoinitiator was 1.0%, and the spacer having a particle size of 2 μm was selected, with a content of 0.5%. The liquid crystal, the photopolymerizable monomer, the photoinitiator and the glass microbeads were stirred uniformly at room temperature, then the mixture was pressed between two indium tin oxide-coated conductive films by using a rolling process to form a thin layer with a thickness of 100 μm, and the thin layer was irradiated at 25° C. for 5 minutes by using ultraviolet light with a light intensity of 10 mw/cm² and a wavelength of 365 nm, so as to prepare an intelligent display film having a switchable viewing angle.

The intelligent display film having a switchable viewing angle obtained by the above preparation method was measured by a micrometer in terms of thickness, and its thickness was 100 μm. As the voltage increases, the transmittance increases. The transmittance in the wide viewing angle state is 80%, the transmittance in the narrow viewing angle state is 90%, and the driving voltage can be as low as 6V, and the intelligent display film has the effect of switching between a wide viewing angle and a narrow viewing angle.

The intelligent display film having a switchable viewing angle was added to a liquid crystal display backlight module, and its viewing angle-brightness curve is as shown in FIG. 6. With the change of the driving voltage, there is a certain change in the viewing angle, and thus the effect of adjusting the viewing angle is achieved. FIG. 7 shows a diagram illustrating the principle of the wide viewing angle mode and the narrow viewing angle mode of the intelligent display film having a switchable viewing angle.

### Example 4

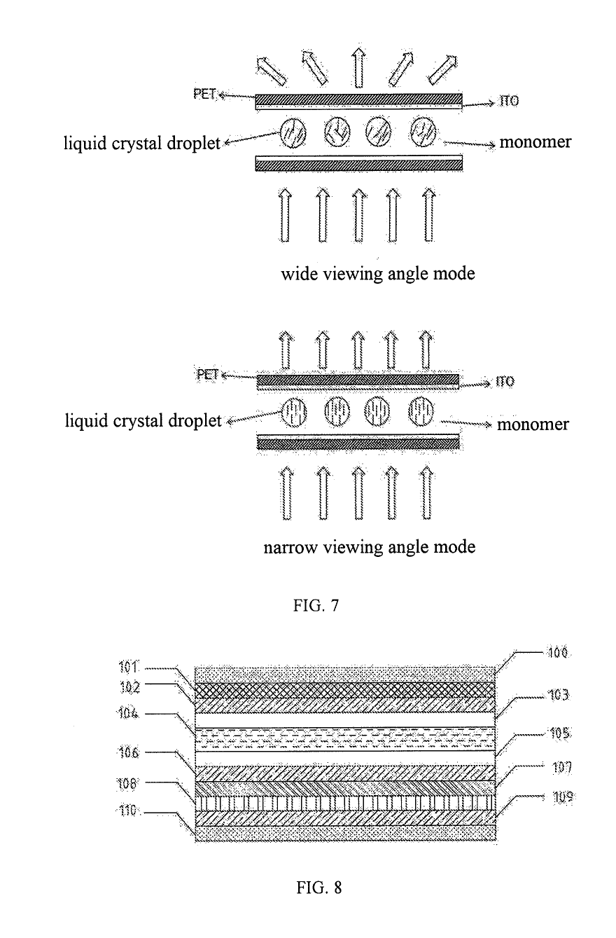

FIG. 8 shows a cross-sectional structural view of an intelligent display composite film having a switchable viewing angle in this example. As shown in FIG. 8, the composite film includes: a first release protective film layer 100, an anti-glare coating layer 101, a first PET layer 102, a first indium tin oxide conductive layer 103, a polymer-dispersed liquid crystal layer 104, a second indium tin oxide conductive layer 105, a second PET layer 106, an optical grade glue layer 107, an ultrafine louver layer 108, a third PET layer 109, and a second release protective film layer 110; the anti-glare coating layer 101 is disposed under the first release protective film layer 100, the first PET layer 102 is disposed under the anti-glare coating layer 101, and the first indium tin oxide conductive layer 103 is disposed under the first PET layer 102; the polymer-dispersed liquid crystal layer 104 is disposed under the first indium tin oxide conductive layer 103, and the polymer liquid crystal layer comprises liquid crystal droplets, and the polymer-dispersed liquid crystal layer is formed by polymerizing a nematic liquid crystal and an acrylate monomer through 365 nm UV light; the second indium tin oxide conductive layer 105 is disposed under the polymer-dispersed liquid crystal layer 104, the second PET layer 106 is disposed under the second indium tin oxide conductive layer 105, the optical grade glue layer 107 is disposed under the second PET layer 106, the ultrafine louver layer 108 is disposed under the optical grade glue layer 107, the third PET layer 109 is disposed under the ultrafine louver layer 108, and the second release protective film layer 110 is disposed under the third PET layer 109.

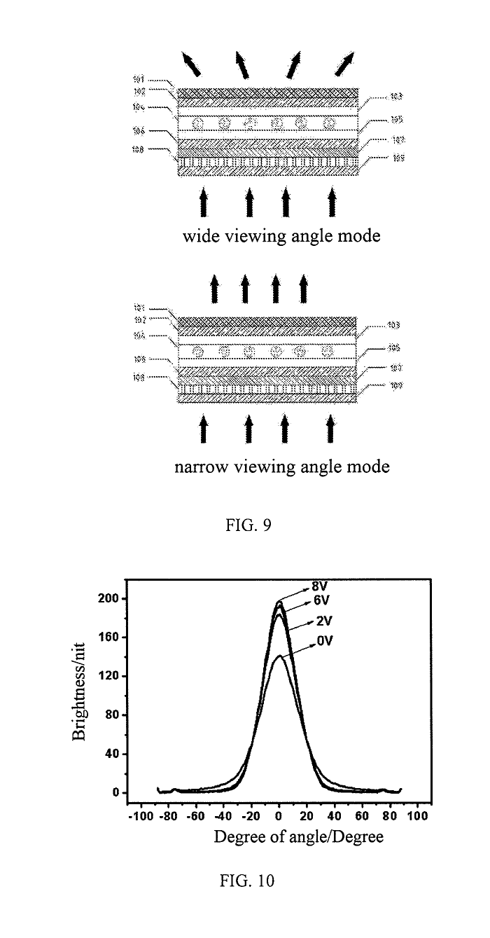

When the power is not applied, the light from a backlight passes through the ultrafine louver layer 108 to form a narrow viewing angle, and then enters the polymer-dispersed liquid crystal layer 104, and is uniformly dispersed due to the light scattering of the liquid crystal layer, so that the transmitted light forms a wide viewing angle mode. When the power is applied, the light from a backlight passes through the ultrafine louver layer 108 to form a narrow viewing angle, and then enters the polymer-dispersed liquid crystal layer 104, where it is directly transmitted without being scattered by the liquid crystal layer, and in this way the narrow viewing angle mode is formed. A diagram illustrating the structural principle of the wide and narrow viewing angle modes of the intelligent display composite film having a switchable viewing angle is as shown in FIG. 9.

The intelligent display composite film having a switchable viewing angle was measured by a micrometer in terms of thickness and its thickness was 500 μm. As the voltage increases, the transmittance increases. The transmittance in the light scattering state is 78%, the transmittance in the transparent state is 92%, and the driving voltage can be as low as 8V.

The intelligent display composite film having a switchable viewing angle was added to a liquid crystal display backlight module, and its viewing angle-brightness curve is as shown in FIG. 10. With the change of the driving voltage, the intelligent display composite film having a switchable viewing angle realizes the effect of switching between a wide viewing angle and a narrow viewing angle.

### Example 5

FIG. 11 shows a cross-sectional structural view of a self-adhesive intelligent display composite film having a switchable viewing angle in this example. As shown in FIG. 11, the film includes: a first release protective film layer 100, an anti-glare coating layer 101, a first PET layer 102, a first indium tin oxide conductive layer 103, a polymer-dispersed liquid crystal layer 104, a second indium tin oxide conductive layer 105, a second PET layer 106, an optical grade glue layer 107, an ultrafine louver layer 108, a third PET layer 109, a second release protective film layer 110 and a self-adhesive layer 111; the anti-glare coating layer 101 is disposed under the first release protective film layer 100, the first PET layer 102 is disposed under the anti-glare coating layer 101, and the first indium tin oxide conductive layer 103 is disposed under the first PET layer 102; the polymer-dispersed liquid crystal layer 104 is disposed under the first indium tin oxide conductive layer 103, and the polymer liquid crystal layer comprises liquid crystal droplets, and the polymer-dispersed liquid crystal layer is formed by polymerizing a nematic liquid crystal and an acrylate monomer through 365 nm UV light; the second indium tin oxide conductive layer 105 is disposed under the polymer-dispersed liquid crystal layer 104, the second PET layer 106 is disposed under the second indium tin oxide conductive layer 105, the optical grade glue layer 107 is disposed under the second PET layer 106, the ultrafine louver layer 108 is disposed under the optical grade glue layer 107, the third PET layer 109 is disposed under the ultrafine louver layer 108, the self-adhesive layer 111 is disposed under the third PET layer 109, and the second release protective film layer 110 is disposed under the self-adhesive layer 111.

When the power is not applied, the light from a backlight passes through the ultrafine louver layer 108 to form a narrow viewing angle, and then enters the polymer-dispersed liquid crystal layer 104, and is uniformly dispersed due to the light scattering of the liquid crystal layer, so that the transmitted light forms a wide viewing angle mode. When the power is applied, the light from a backlight passes through the ultrafine louver layer 108 to form a narrow viewing angle, and then enters the polymer-dispersed liquid crystal layer 104, where it is directly transmitted without being scattered by the liquid crystal layer, and in this way the narrow viewing angle mode is formed.

The refractive index of the intelligent display composite film base having a switchable viewing angle is 1.52, the refractive index of the polymer-dispersed liquid crystal layer is 1.50, and the overall refractive index matches the optical film in a backlight module. The refractive index of the film having a switchable viewing angle can be adjusted by raw material selection. The intelligent display composite film was measured by a micrometer in terms of thickness and its thickness is 600 μm. As the voltage increases, the transmittance increases. When the power is not applied, the transmittance in the light scattering state is 76%; when the power is applied, the transmittance in the transparent state is 90%, and the driving voltage can be as low as 10V.

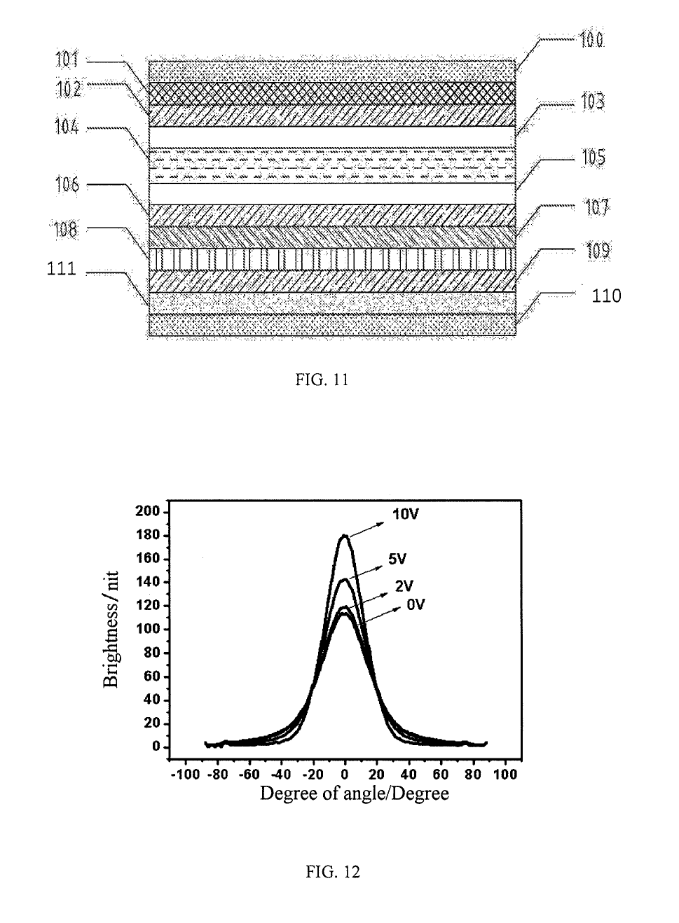

The intelligent display composite film having a switchable viewing angle was added to a liquid crystal display backlight module, and its viewing angle-brightness curve is as shown in FIG. 12. With the change of the driving voltage, there is a change in the viewing angle, and thus the effect of adjusting the viewing angle is achieved. A viewing angle-brightness curve of the intelligent display composite film was measured in the liquid crystal display backlight module, as shown in FIG. 12. With the change of the driving voltage, the intelligent display composite film having a switchable viewing angle realizes the effect of switching between a wide viewing angle and a narrow viewing angle.

The intelligent display film having a switchable viewing angle provided in the present invention has an adjustable refractive index, which matches other optical display films in the display backlight module. The intelligent display film has no light quality effect on the backlight display effect and possesses good display characteristics, which can be applied to the fields of optical displays such as computers, smart phones and ATM displays.

Although the present invention has been described with reference to the accompanying drawings, the examples disclosed in the drawings are intended to exemplify the preferred embodiments of the present invention and should not be construed as limitation to the present invention.

Although some examples of the general inventive concept have been shown and described herein, those of ordinary skill in the art will appreciate that numerous variations can be made to these examples without departing from the principle and spirit of the general inventive concept, and the scope of the present invention is defined by the claims and their equivalents.

1. A method for preparing an intelligent display film having a switchable viewing angle, comprising:
mixing liquid crystal and a photopolymerizable monomer according to certain percentage content, wherein the ratio of raw materials is selected according to the refractive index matching ability between a conductive film and a polymer-dispersed liquid crystal layer as well as the characteristics of material components, and wherein the percentage content of the liquid crystal is 30-60%, the percentage content of the photopolymerizable monomer is 38-70%, the percentage content of a photoinitiator is 0.1-3.5%, the percentage content of a spacer is 0.1-5%; stirring the liquid crystal, the photopolymerizable monomer, the photoinitiator and the spacer evenly at room temperature, pressing the mixed material between two indium tin oxide-coated conductive films by using a rolling process to form a thin layer, and irradiating the thin layer for 5-10 minutes by using ultraviolet light, so as to prepare the intelligent display film having a switchable viewing angle.

2. The method for preparing an intelligent display film having a switchable viewing angle according to claim 1, wherein the intelligent display film having a switchable viewing angle has a wide viewing angle in the non-powered state and a narrow viewing angle in the powered state, and the adjustment between a wide viewing angle and a narrow viewing angle can be achieved by adjusting the magnitude of the externally-applied voltage.

3. The method for preparing an intelligent display film having a switchable viewing angle according to claim 1, wherein the liquid crystal is a nematic liquid crystal having a refractive index of 1.4-1.52.

4. The method for preparing an intelligent display film having a switchable viewing angle according to claim 1, wherein the photopolymerizable monomer is a photopolymerizable monomer having a refractive index of 1.4-1.52.

5. The method for preparing an intelligent display film having a switchable viewing angle according to claim 1, wherein the photopolymerizable monomer comprises one or more components of hydroxypropyl acrylate, hydroxypropyl methacrylate, lauryl acrylate, lauryl methacrylate, isobornyl acrylate, isobornyl methacrylate, 1,6-hexanediol diacrylate, ethylphenoxy acrylate, ethylphenoxy methacrylate, 3,3,5-trimethylcyclohexyl acrylate, benzyl methacrylate, hexyl acrylate, hexyl methacrylate, polyethylene glycol diacrylate, ethoxylated bisphenol A dimethacrylate.

6. The method for preparing an intelligent display film having a switchable viewing angle according to claim 1, wherein the refractive index of the indium tin oxide-coated conductive film is between 1.46 and 1.52, and the refractive index of the polymer-dispersed liquid crystal layer is close to that of the conductive film.

7. The method for preparing an intelligent display film having a switchable viewing angle according to claim 1, wherein the spacer has a particle size of 2-10 μm.

8. The method for preparing an intelligent display film having a switchable viewing angle according to claim 1, wherein the intelligent display film having a switchable viewing angle has a transmittance of ≥76% in the wide viewing angle state, and a transmittance of ≥88% in the narrow viewing angle state.

9. The method for preparing an intelligent display film having a switchable viewing angle according to claim 1, wherein the intelligent display film having a switchable viewing angle has a driving voltage AC of 0-10V, and a film thickness of 100 μm.

10. A composite film comprising an intelligent display film having a switchable viewing angle, comprising the structure of: a first release protective film layer, an anti-glare coating layer, a first PET layer a first indium tin oxide conductive layer a polymer-dispersed liquid crystal layer, a second indium tin oxide conductive layer, a second PET layer, an optical grade glue layer, an ultrafine louver layer, a third PET layer, and a second release protective film layer which are arranged in order from top to bottom.

11. The composite film comprising an intelligent display film having a switchable viewing angle according to claim 10, wherein a self-adhesive layer is disposed between the third PET layer and the second release protective film layer.

12. The composite film comprising an intelligent display film having a switchable viewing angle according to claim 10, wherein the polymer-dispersed liquid crystal layer is formed by polymerizing a nematic liquid crystal and an acrylate monomer through UV light.

13. The composite film comprising an intelligent display film having a switchable viewing angle according to claim 10, wherein upon the light passes through the ultrafine louver layer, the display effect with a narrow viewing angle of ±30 degrees is formed.

14. The composite film comprising an intelligent display film having a switchable viewing angle according to claim 10, wherein the first PET layer, the second PET layer, the first indium tin oxide layer and the second indium tin oxide layer, and the polymer-dispersed liquid crystal layer have similar refractive indices, which are all between 1.45 and 1.5.

15. The composite film comprising an intelligent display film having a switchable viewing angle according to claim 10, wherein the composite film comprising an intelligent display film having a switchable viewing angle has a wide viewing angle of ±60 degrees in the non-powered state and a narrow viewing angle of ±30 degrees in the powered state.

16. The composite film comprising an intelligent display film having a switchable viewing angle according to claim 10, wherein the composite film comprising an intelligent display film having a switchable viewing angle has a transmittance of ≥75% in the wide viewing angle state, and a transmittance of ≥90% in the narrow viewing angle state.

17. The composite film comprising an intelligent display film having a switchable viewing angle according to claim 10, wherein the composite film comprising an intelligent display film having a switchable viewing angle has a driving voltage AC of 0-10V, and a film thickness of 500-600 μm.
